(19) United States
(12) Patent Application Publication
(10) Pub. No.: US 2010/0001029 A1
(43) Pub. Date: Jan. 7, 2010

(54) WHEEL-LESS CARGO CARRIER WITH EXTENDABLE BEAMS

(76) Inventor: Paul K. Tai, Sunnyvale, CA (US)

Correspondence Address: PATENT LAW OFFICES OF DAVID MILLERS, 1221 Sun Ridge Road, Placerville, CA, 95667, US

(21) Appl. No.: 12/496,565

(22) Filed: Jul. 1, 2009

Related U.S. Application Data
(60) Provisional application No. 61/077,796, filed on Jul. 2, 2008.

(51) Int. Cl. B60R 9/06

(52) U.S. Cl. 224/499; 224/510

(57) ABSTRACT

A wheel-less cargo carrier or dolly has multiple telescoping or expandable support beams that can remain attached to a vehicle in a retracted configuration when not in use. For use of the wheel-less cargo carrier, the beams are extended and engaged with a floor, fence, or other structural portion of the wheel-less cargo carrier. Telescoping beams can include multiple rails where smaller rails nest within larger rails and slide relative to the larger rails as the beams are being extended or collapsed. The rails can share a common top surface, so that a base or floor of the wheel-less cargo carrier lies on a flat support structure.

### CROSS-REFERENCE TO RELATED APPLICATIONS

This patent document claims benefit of the earlier filing date of U.S. provisional patent application 61/077,796, filed Jul. 2, 2008, which is hereby incorporated by reference in its entirety.

### BACKGROUND

Many people have an occasional need to transport bulky objects that do not easily fit in their car. Even those with sport utility vehicles, vans, and station wagons, which have more interior space than many other non-commercial vehicles, are unable to easily transport tall or large objects. Also, when an object would fit in the interior of the vehicle, it is sometimes undesirable to have messy or noxious items sharing the interior space with passengers. A light truck can fulfill many people's cargo transportation needs, but keeping a light truck may not be practical for many because of the cost and space needed for a second vehicle. Conventional trailers, which can be towed behind a vehicle, may also be impractical because of the cost, the need for government registration, and the space required to keep a trailer. Wheeled trailers may also be undesirable because of maneuvering difficulties for occasional users.

Wheel-less cargo carriers such as bike racks are being used to meet some cargo transportation needs. Prior wheel-less cargo carriers generally have a tongue that fits into a standard trailer hitch and are suspended as a cantilever supported by the trailer hitch and the length of the tongue within the hitch. The current systems have obvious structural limitations. In particular, the weight that can be supported depends on strength and length of the tongue and hitch. Additionally, a conventional trailer hitch with a single tongue has a single support that can only withstand minimal torques about the axis of the hitch. As a result, conventional wheel-less cargo carriers are small and have limited weight capacity. Further, although current wheel-less cargo carriers are relatively compact when compared to conventional trailers, they still require storage space when removed from a vehicle.

### SUMMARY

In accordance with an aspect of the invention, a wheel-less cargo carrier or dolly has multiple telescoping or expandable support beams that can remain attached to a vehicle in a retracted configuration when not in use. For use of the wheel-less cargo carrier, the beams are extended and engaged with a floor, base plate, cage panels, or other structural portion of the wheel-less cargo carrier. Telescoping beams can include multiple sliding rails where smaller rails nest within larger rails and slide relative to the larger rails as the beams are being extended or retracted. The rails can share a substantially level common top surface, so that a floor of the wheel-less cargo carrier lies on a flat supporting base. In generally, a floor plate and/or cage panels can be bolted on the sliding rails to provide a rigid structure.

In accordance with a further aspect of the invention, a floor of a wheel-less cargo carrier can include hinge-linked panels that may be removed or left in place in a folded configuration when the wheel-less cargo carrier is not in use. The hinge-linked plates can then be unfolded and bolted or otherwise attached to the extendable beams during use of the wheel-less cargo carrier.

One specific embodiment of the invention is a wheel-less cargo carrier including multiple telescoping support beams that attach to a vehicle. A floor on the telescoping beams carries cargo.

Another specific embodiment of the invention is a method for carrying cargo. The method includes: mounting telescoping beams on a vehicle; extending the beams to a first length to provide a base on which cargo is carried by the vehicle; and retracting the beams when cargo is not being carried.

### BRIEF DESCRIPTION OF THE DRAWINGS

FIGS. 1A and 1B show extended configurations of wheel-less cargo carriers respectively using an under-body mounting system and an in-trunk mounting system in accordance with alternative embodiments of the invention.

FIGS. 1C and 1D respectively show the wheel-less cargo carriers of FIGS. 1A and 1B when in a retracted configuration.

FIGS. 1E and 1F show a wheel-less cargo carrier in accordance with an embodiment of the invention in which telescoping support beams form part of a drawer built into a vehicle.

FIG. 2 shows a perspective view of a telescoping beam in accordance with an embodiment of the invention when sliding rails are in a retracted position.

FIGS. 3A, 3B, and 3C show separate sliding rails employed in the telescoping beam of FIG. 2.

FIG. 4 illustrates the use of rollers in the support beam of FIG. 2.

FIGS. 5A, 5B, and 5C show a support base structure including extendable beams respectively with different degrees of extension.

FIG. 6 shows a portion of a floor in accordance with an embodiment of the invention using folding floor sections linked by piano hinges.

Use of the same reference symbols in different figures indicates similar or identical items.

### DETAILED DESCRIPTION

In accordance with an aspect of the invention, a wheel-less cargo carrier can employ multiple telescoping support beams that are put in a retracted position and left attached to a vehicle when not in use. The support beams are extended when forming a support base for carrying cargo in the wheel-less cargo carrier. A floor attaches to the support base when the cargo carrier is in use, and to further reduce storage space, the floor can have an accordion-like folded structure that may remain attached to the vehicle when not is use or may be removed and stored in the vehicle or elsewhere. Additionally, a fence, basket, cage, or other cargo retaining structure with or without a gate or ramp may be attached to the support base and/or floor. The cargo carrier can be an after market addition to a vehicle or a factory built feature of the vehicle. A factory built cargo carrier can more easily be included in a drawer-like installation in which the telescoping support beams extend when a drawer is pulled out and hidden when the drawer is closed.

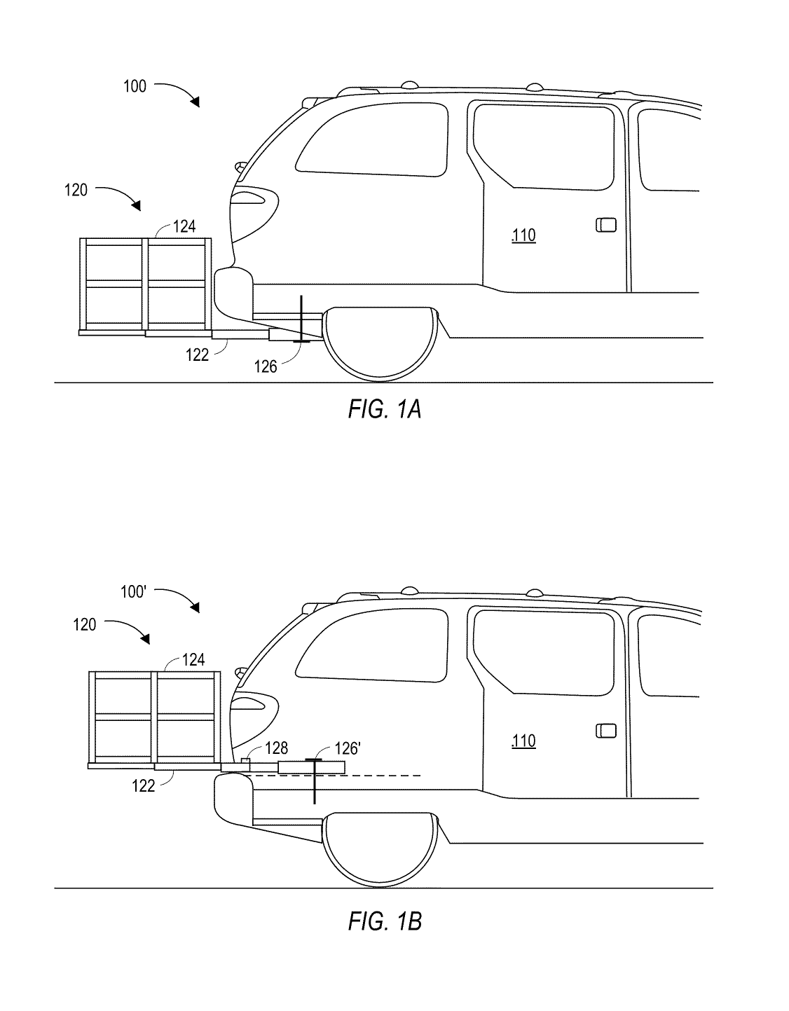

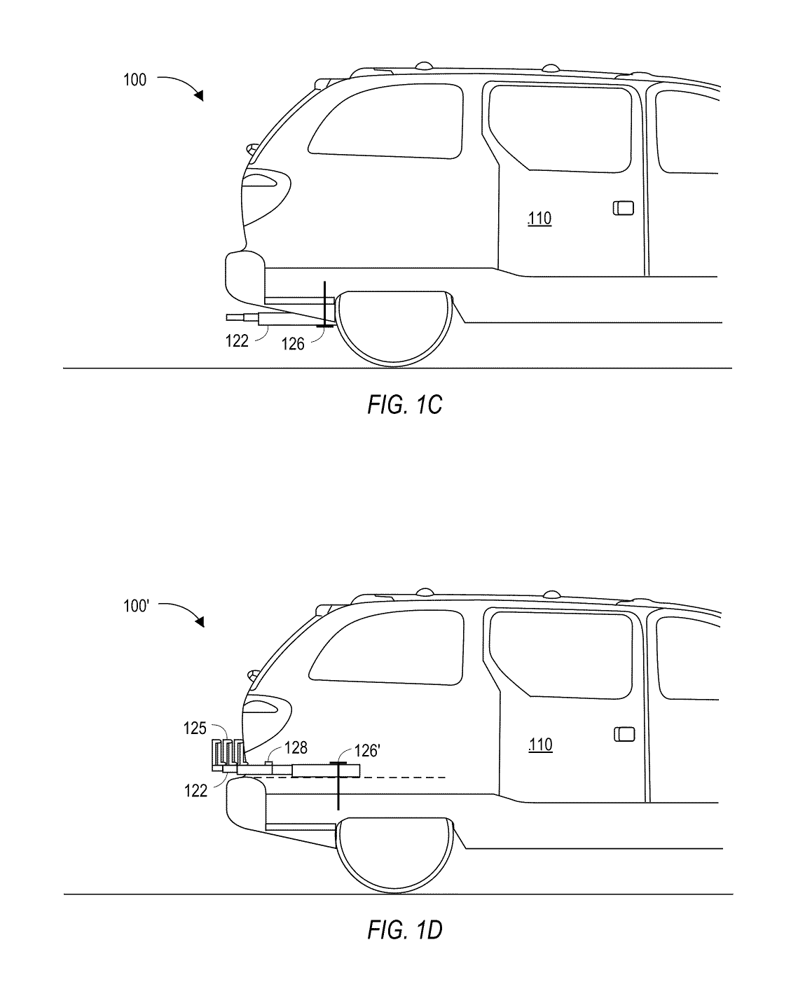

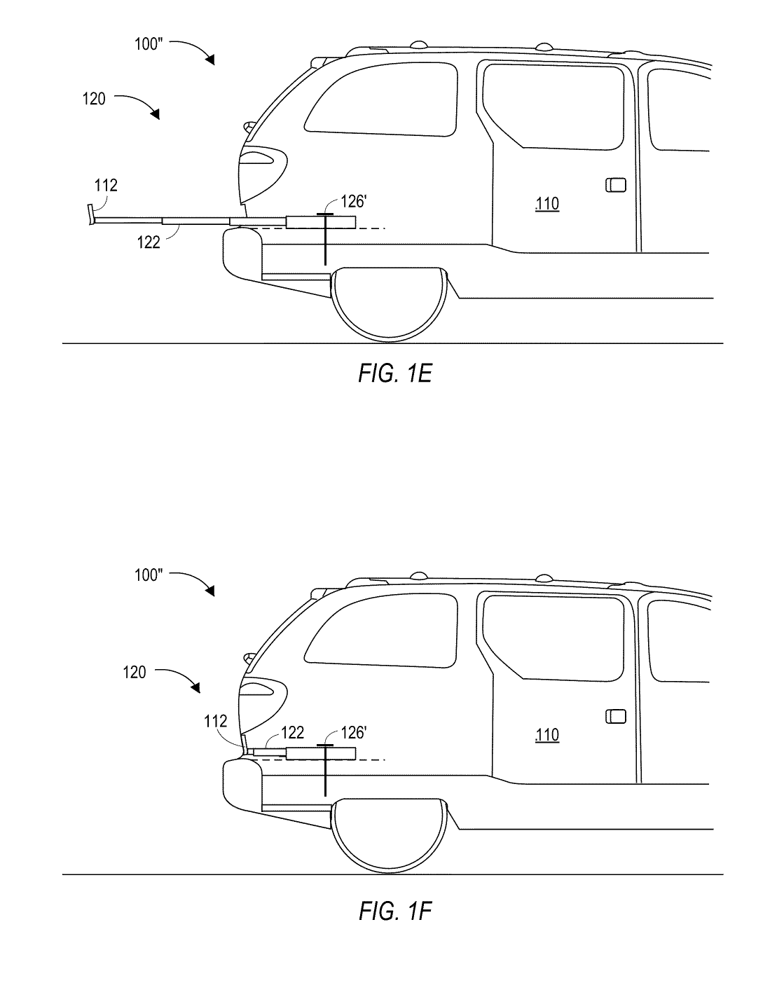

FIG. 1A shows a system 100 including a vehicle 110 with a wheel-less cargo carrier 120 in accordance with an exemplary embodiment of the invention. Vehicle 110 can be any type of automobile including but not limited to a passenger car, a sports utility vehicle, a van, or a truck of any make or model. In the illustrated embodiment, wheel-less cargo carrier 120 is an after market product that can be installed on a vehicle after manufacture of vehicle 110, and vehicle 110 does not require any special features, other than sufficient space and a suitably strong structure for attachment of cargo carrier 120 to vehicle 110.

Wheel-less cargo carrier 120 includes support beams 122, and a cargo cage 124. Support beams 122 are attached to vehicle 110 using a mounting system 126, which in the embodiment of FIG. 1A attaches under the body of vehicle 110. Mounting system 126 may include steel mounting structure (e.g., 3-inch square steel tubing) that attaches to support beams 122 and the frame of vehicle 110 or to one or more suitably strong structural members of the body of vehicle 110. In general, mounting system 126 will have a design that is adapted to the particular model of vehicle 110 and can attach to vehicle 110 in the same manner as the attachments of trailer hitches, which are well known in the art. Mounting system 126 may include welds, bolts, or other fasteners that hold support beams 122 in place and are not casually removed. Accordingly, support beams 122 effectively remain a permanent feature of vehicle 110.

Cargo cage 124 generally includes a floor that rests on and attaches to support beams 122 and a fence (e.g., a hinge-linked basket or cage) with or without gate or ramp structures. More specifically, cargo cage 120 optionally includes a gate or ramp that is opened for loading of cargo onto the floor of cargo cage 124 and may be closed so that the gate or ramp helps keep cargo within a perimeter of cargo cage 120. Cargo cage 124 can be made of any suitably strong material but is preferably made of a light weight metal such as an aluminum alloy or a durable plastic or composite material that that may be reinforced with metal or other material. Cargo cage 124 may also include reflectors, tail lights, or other safety features. Preferably, cargo cage 124 is fully or partially removable from support beams 122 and may be folded up into a compact unit for storage inside or outside vehicle 110. As described further below, a portion of cargo cage 124, e.g., the floor, may be left attached to support beams 122 when the fence or basket structure is removed.

FIG. 1B shows an alternative system 100′ in which vehicle 110 uses wheel-less cargo carrier 120. Vehicle 110 and wheel-less cargo carrier 120 in FIG. 1B can be substantially the same as described above with reference to FIG. 1A with the exception that a mounting system 126′ of FIG. 1B attaches support beams 122 in the trunk or other interior space of vehicle 110. Accordingly, the body of vehicle 110 in FIG. 1B may require minor modification to add openings 128 through which support beams 122 can extend from vehicle 110. Opening 128 may be equipped with a flexible boot (not shown) that seals around support beams 122. Alternatively, if support beams 122 can be fully retracted into vehicle 110, rubber caps or other structures may seal openings 128 against the weather when wheel-less cargo carrier 120 is not in use. In another embodiment, which is well suited for factory installation, a drawer face attached to the ends of support beams 122 matches the contours and color of the rest of the body of vehicle 110 and hides beams 122 when the beams are retracted (i.e., when the drawer is closed.)

An advantage of system 100′ is that cargo cage 120 may be positioned closer to the back wheels of vehicle 110, for example, have an edge overlapping the back bumper of vehicle 110, reducing the lever arm on which the weight of cargo acts on mounting system 126′. The length of system 100′ of FIG. 1B may also be somewhat less than the length of system 100 of FIG. 1A, and a front fulcrum or pivot point of the cantilevered structure is supported an underlying portion of the vehicle, rather than from above by a welded or bolted attachment. System 100 thus has some structural or strength advantages. Cargo cage 124 is also higher in system 100′, which provides more ground clearance during driving of vehicle 110. However, the added height may make loading from the ground into cargo cage 124 more difficult with system 100′. Openings 128 used in system 100′ may also be less desirable cosmetically and may present weather proofing concerns.

FIGS. 1C and 1D respectively show systems 100 and 100′ in configurations where support beams 122 are retracted. In FIG. 1C, cargo cage 124 has been removed, and support beams 122 have been retracted so that the end of support beams 122 do not extend beyond the rear bumper of vehicle 110. In FIG. 1D, a floor 125 of cargo cage 124 is attached to support beams. Generally, floor 125 and cargo cage 124 are removed and folded into a compact configuration for storage in the trunk of vehicle 110. Alternatively, when wheel-less cargo carrier 120 is not in use, floor 125 when folded up can be stowed on support beams 122 as shown in FIG. 1D. In one such embodiment, folding floor 125 of FIG. 1D may be permanently attached to support beams 122 and folds up as support beams are retracted. However, floor 125 may alternatively be removed, unfolded, and reattached when support beams 122 are extended, and removed, folded, and reattached to support beams 122 when support beams 122 are retracted. A cover (not shown) can fit over support beams 122 with or without folding floor 124 to improve appearance or weather proofing.

An automotive system 100″ as shown in FIGS. 1E and 1F can include beams 122 as part of a drawer system having a drawer front 112. FIG. 1E shows system 100″ when support beams 122 are extended to open the drawer system. A floor and cargo cage or basket can then be placed on beams for carrying cargo as described above with reference to FIGS. 1A and 1B. The drawer system can be closed as shown in FIG. 1F so that support beams 122 are retracted and hidden. Drawer front 112 can have a shape and color matching the rest of the body of vehicle 110, so that cargo carrier 120 is unobtrusive when not in use.

Support beams 122 are telescoping beams and are extended in FIGS. 1A, 1B, and 1E and retracted in FIGS. 1C, 1D, and 1F. A power system (not shown) may be used to retract and/or extend support beams 122. For example, an electric motor and gear system or a hydraulic piston system can extend or retract support beams 122. However, for simplicity of construction and reduced cost, a manual system in which a person pulls on support beams 122 to extend beams 122 to the position of FIG. 1A, 1B, or 1E or pushes on support beams 122 to retract support beams 122 to the position of FIG. 1C, 1D, or 1F may be preferred.

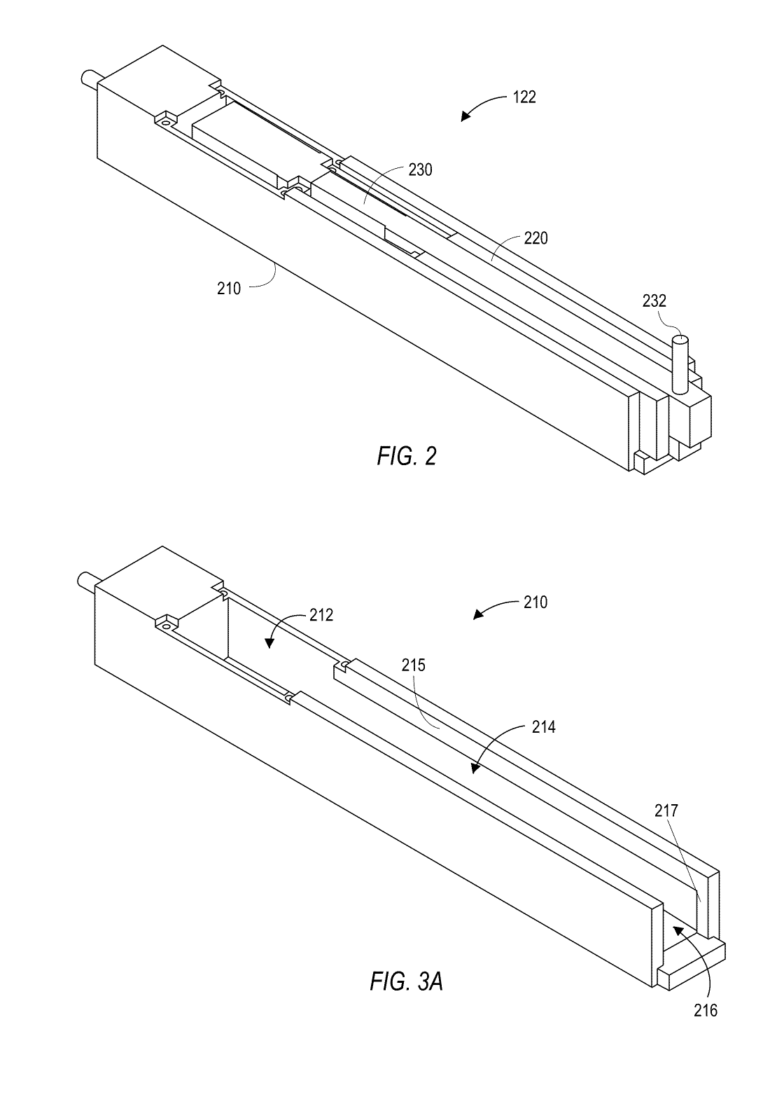

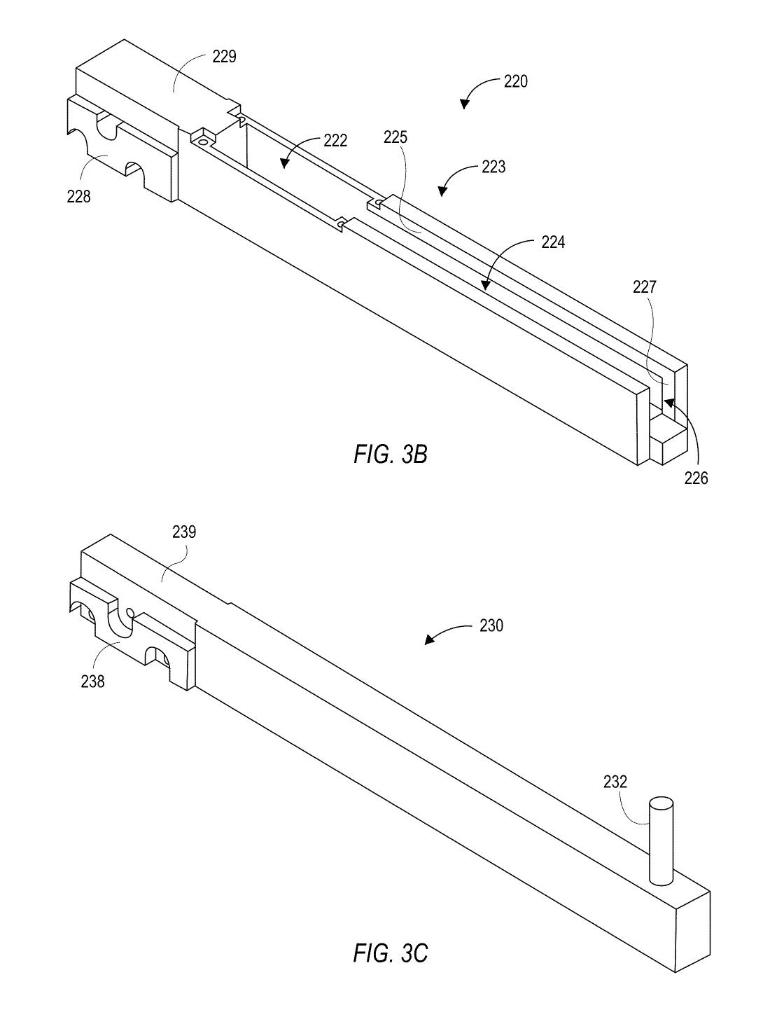

FIG. 2 shows a perspective view of a support beam 122 in accordance with an exemplary embodiment of the invention. In the illustrated embodiment, support beam 122 includes a rail holder 210, a middle sliding rail 220, and a inner sliding rail 230. Alternative embodiments of a telescoping beam may include additional rails. FIGS. 3A, 3B, and 3C respectively show views of rail holder 210, middle sliding rail 220, and inner sliding rail 230 as separate components before assembly in support beam 122 of FIG. 2 and are described in conjunction with FIG. 2. Each of rails 210, 220, and 230 are preferably made of a strong light weight material such as an aluminum alloy and may be machined, forged, or assembled to provide their desired shapes. To assemble support beam 122, inner sliding rail 230 can be inserted into middle sliding rail 220, and the assembly including rails 230 and 220 can be inserted into rail holder 210.

Rail holder 210 is generally box shaped and in an exemplary embodiment is about 60 to 65 cm long, about 7 to 8 cm high, and about 7 to 8 cm wide. The top of rail holder 210 has openings 212 and 214, and an opening 216 is in an end wall of rail holder 210. Openings 214 and 216 respectively leave lips 215 and 217 that contact and guide middle sliding rail 220 as described further below. In use, the mounting system for support beam 122 generally fixes rail holder 210 in place relative to the vehicle. For example, rail holder 210 can be fit into and bolted to a section of square steel tubing that is anchored to the frame of a vehicle.

Middle rail 220 includes a box shaped section 223 having top openings 222 and 224 and an end opening 226 similar to those found on rail holder 210. Middle rail 220 also includes a guide section 229 having protrusions 228 that make guide section 229 wider than box section 223. For example, middle rail 220 may be about 45 to 50 cm long, about 6 cm high, and about 4.8 cm wide, except where protrusions 228 make guide section 229 about 6.4 cm. Openings 212 and 214 in rail holder 220 are sized so that guide section 229 can be inserted into rail holder 210 through opening 212 while box section 223 is inserted through opening 214. After middle rail 220 is inserted in rail holder 210, sliding middle rail 220 causes protrusions 228 to fit under top lip 215 in rail holder 210, preventing upward force or rotational torque from lifting guide section 229 from rail holder 210. A cover (not shown) can be secured over opening 212 after insertion of middle rail 220 to prevent removal of middle rail 220 from rail holder 210. Middle rail 220 when in rail holder 210 can slide forward and extend further from rail holder 210 until protrusions 228 reach and are stopped by front lip 217 of rail holder 210. The height of middle rail 220 and the thickness of the bottom of rail holder 210 are chosen so that the top of middle rail 220 when inserted in rail holder 210 is substantially coplanar with the top of rail holder 210.

Inner rail 230 is substantially box shaped except for protrusions 238 and post 232. In the exemplary embodiment, inner rail 230 may be about 45 to 50 cm long, about 4 cm high, and about 2.5 cm wide, except where protrusions 238 make inner rail 230 about 3.8 cm wide. Openings 222 and 224 in middle rail 220 are sized so that protrusion 238 can be inserted into middle rail 220 through opening 222 while the remainder of inner rail 230 fits through openings 224 and 226. After inner rail 230 is inserted in middle rail 220, sliding inner rail 230 causes protrusions 238 to fit under a top lip 225 in middle rail 220, preventing upward force or rotational torque from lifting protrusions 238 from middle rail 220. Inner rail 230 when inserted in middle rail 220 is able to slide forward and extend further from middle rail 220 until protrusions 238 reach and are stopped by front lips 227 of middle rail 220. The height of inner rail 230 and the thickness of the bottom of middle rail 220 are chosen so that the top of inner rail 230 when inserted in middle rail 220 is substantially coplanar with the tops of middle rail 220 and rail holder 210.

A post or bolt 232, which extends upward from inner rail 230, acts as a handle to help a user to push or pull on inner rail 230 when extending or retracting support beam 122. Post 232 can also be used for rapid and secure attachment of other portions (e.g., a cross beam or fence and gate structures) of a wheel-less cargo carrier including support beam 122.

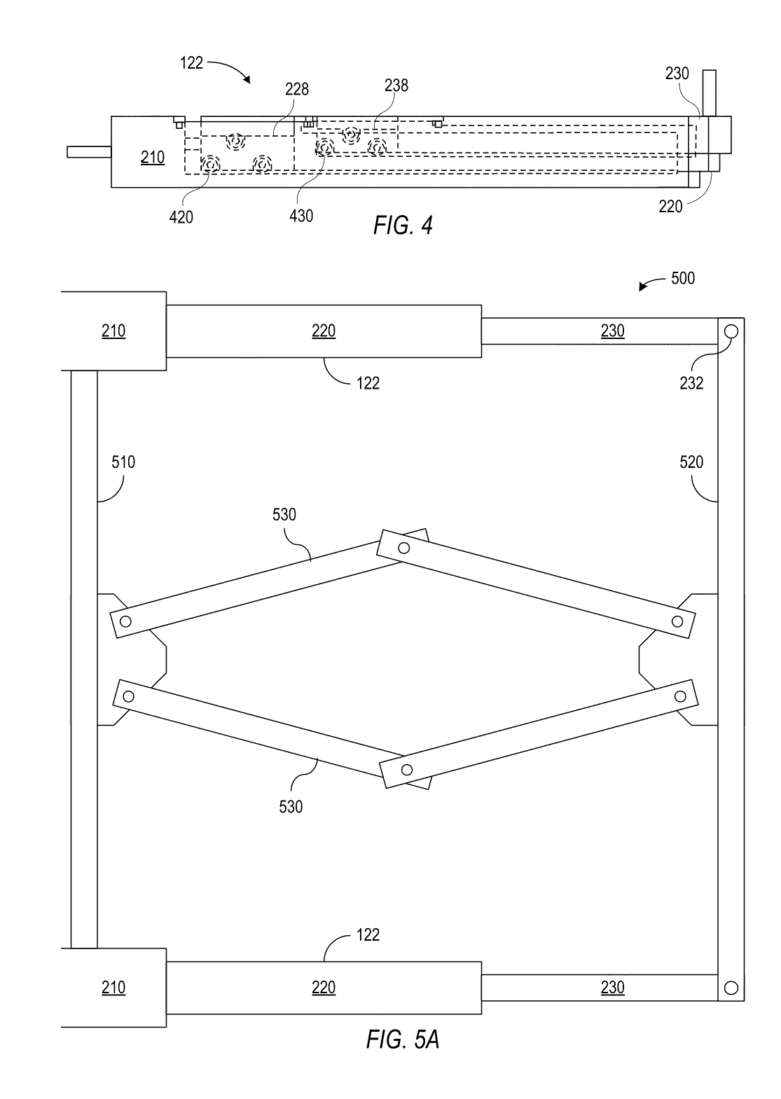

FIG. 4 shows a semi-transparent view of an embodiment of support beam 122. As described above, rails 230, 220, and 210 in support beam 122 are nested so that the tops of rails 230, 220, and 210 are coplanar, which provides a flat and level surface for supporting the floor of a wheel-less cargo carrier. Beam 122 also extends and retracts in telescope fashion through the sliding of inner rail 230 relative to middle rail 220 and the sliding of middle rail 220 relative to rail holder 210. Protrusions 238 from inner rail 230 engage notches in the side walls of middle rail 220 to guide movement of inner rail 230, and protrusions 228 from middle rail 230 engage notches in the side walls of rail holder 210 to guide movement of middle rail 220. As illustrated in FIG. 4, rollers 420 and 430 can be provided where protrusions 228 and 238 respectively contact rail holder 210 and middle rail 220.

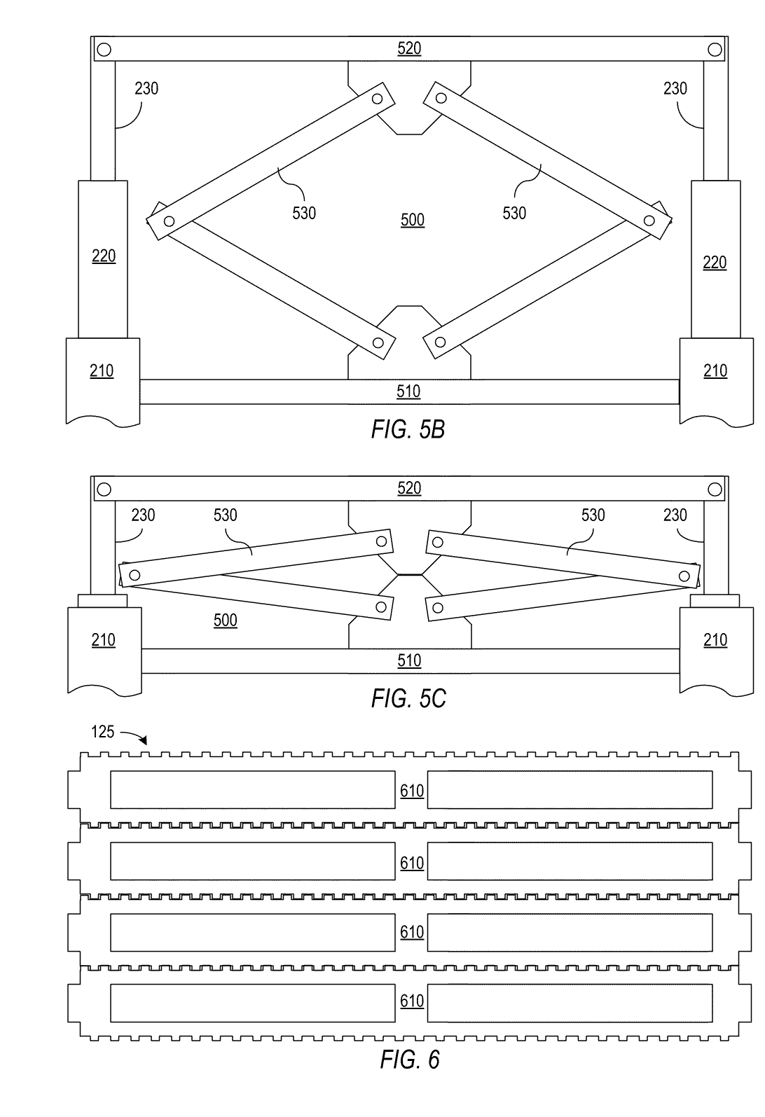

FIG. 5A shows a support base 500 for a wheel-less cargo carrier in accordance with an embodiment of the invention. Base 500 includes two telescoping support beams 122, a back cross beam 510, and a front cross beam 520. As illustrated, holes in cross beam 520 may fit over posts 232 in inner rails 230. Base 500 also includes one or more folding beams 530, which are pivotally attached to cross beams 510 and 520 and hinged to permit beams 530 to fold while maintaining a top surface of beams 530 in the plane of the top surfaces of telescoping beams 122. In an alternative embodiment, folding beams 530 could be replaced with one or more additional telescoping beams 122, but if base 500 is mounted under a vehicle body, center telescoping rails may interfere with access to a spare tire or use of a cargo carrier hitch on the vehicle. However, for mounting above the floor or under body of the vehicle, replacing folding beams 530 with a pair of telescoping support beams may be preferred.

The use of multiple telescoping beams 122 (e.g., two in FIG. 5A or four in an embodiment that replaces folding beams 530 with two telescoping beams) increases the amount of weight that base 500 can support when compared to a system suspended from a trailer hitch. Multiple beams 122 also provide stability against torques about the axis of a trailer hitch, which is important when cargo is not perfectly balanced about the hitch axis. Accordingly, embodiments of base 500 can achieve carrying capacities of up to hundreds of pounds without the need for expensive materials.

FIG. 5A shows base 500 in a fully extended configuration. The fully extended configuration provides the most floor space for the wheel-less cargo carrier but also provides the greatest moment arm on the mountings of beams 122 to a vehicle and the longest vehicle length (including cargo carrier). The long moment arm may decrease the maximum weight load of the wheel-less cargo carrier and may make the vehicle less maneuverable.

In accordance with an aspect of the invention, the wheel-less cargo carrier can be used in fully extended configuration of FIG. 5A or in a partially extended (e.g., half length) configuration. FIG. 5B shows a partially extended configuration for platform 500. This configuration differs from the configuration of FIG. 5A in that telescoping beams 122 are less extended and folding beams 530 are more folded. This provides less cargo floor area but less moment arm, so that heavy cargo might be more safely transported.

FIG. 5C shows a fully retracted configuration of base 500. Platform 500 may be retracted as shown in FIG. 5C when the wheel-less cargo carrier is not in use. However, to provide a more compact not-in-use configuration, cross-beams 510 and 520 and folding beams 510 may be removed and stored externally or in the vehicle, so that beams 122 can be fully retracted.

In accordance with a further aspect of the invention, a floor for a wheel-less cargo carrier may include hinged panels. FIG. 6, for example, illustrates a floor 125 containing multiple panels 610. Each panel 610 may be made of a suitably strong material such as wood or metal and has a hinge structure along its edge with each adjacent panel 610. The hinge structure may run the entire length of the edge as shown in FIG. 6 or may alternatively include multiple separated hinges. The hinges permit panels 610 to fold accordion style to provide a compact configuration when floor 125 is not in use on a wheel-less cargo carrier. Additionally, one or more panels 610 may be removed from floor 125, for example, by removal of a hinge pin or similar structure. Removal or addition of panels 610 changes the size of floor 125, which may be needed, for example, when the wheel-less cargo carrier 500 is used in the fully extended configuration of FIG. 5A or the partly extended configuration of FIG. 5B.

A cargo cage or basket can include a similar hinged structure that can form a square or rectangle with hinges at 90 degree angles or be folded flat for storage.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. A wheel-less cargo carrier comprising:
a plurality of telescoping support beams that attach to a vehicle; and
a floor on the telescoping beams.

2. The wheel-less cargo carrier of claim 1, wherein each of the telescoping support beams comprises:
a rail holder that attaches to the vehicle;
a first sliding rail nested within the rail holder; and
a second sliding rail nested within the first sliding rail.

3. The wheel-less cargo carrier of claim 2, wherein top surfaces of the rail holder, the first sliding rail, and the second sliding rail are coplanar.

4. The wheel-less cargo carrier of claim 1, wherein the wheel-less cargo carrier has:
a cargo-carrying configuration in which telescoping support beams are extended and the floor is on the telescoping beams; and
a not-in-use configuration wherein the beams are retracted.

5. The wheel-less cargo carrier of claim 4, wherein the wheel-less cargo carrier has a second cargo-carrying configuration wherein telescoping support beams are extended less than in the first-recited cargo-carrying configuration and extended more than in the not-in-use configuration.

6. The wheel-less cargo carrier of claim 4, wherein the floor comprises a plurality of panels that are connected to each other by hinges, wherein in the cargo-carrying configuration floor is flat on the support beams, and in the not-in-use configuration the floor is folded.

7. The wheel-less cargo carrier of claim 1, wherein the floor comprises a plurality of panels that are connected to each other by hinges.

8. The wheel-less cargo carrier of claim 1, further comprising a mounting system that attaches the telescoping beams under a body of the vehicle.

9. The wheel-less cargo carrier of claim 1, further comprising a mounting system that attaches the telescoping beams above an underbody of the vehicle.

10. The wheel-less cargo carrier of claim 1, further comprising a body section attached to the telescoping beams, wherein when the telescoping beams are retraced the body section matches contours of a body of the vehicle.

11. The wheel-less cargo carrier of claim 10, wherein the telescoping beams and the body section are portions of a drawer system built into the vehicle.

12. A method for carrying cargo, comprising:
mounting a plurality of telescoping beams on a vehicle;
extending the beams to a first length to provide a base on which a first cargo is carried by the vehicle; and
retracting the beams when cargo is not being carried.

13. The method of claim 12, further comprising extending the beams to a second length that is shorter than the first length to provide a base on which a second cargo is carried by the vehicle.

14. The method of claim 12, wherein extending the beams comprises opening a drawer system that is built into the vehicle, the drawer system having a front that matches contours of the vehicle.
